(19) United States
(12) Patent Application Publication
(10) Pub. No.: US 2005/0264204 A1
(43) Pub. Date: Dec. 1, 2005

(54) Plasma Display Panel (PDP)

(76) Inventors: Tae-Ho Lee, Suwon-si (KR); Eui-Jeong Hwang, Suwon-si (KR); Min-Sun Yoo, Suwon-si (KR)

Correspondence Address: Robert E. Bushnell;Suite 300, 1522 K Street, N.W., Washington, DC, 20005-1202, US

(21) Appl. No.: 11/133,262

(22) Filed: May 20, 2005

(30) Foreign Application Priority Data
May 28, 2004 (KR) 10-2004-0038172

(51) Int. Cl. H01J 17/49

(52) U.S. Cl. 313/584

(57) ABSTRACT

A Plasma Display Panel (PDP) includes: front and rear substrates facing each other; address electrodes arranged on the rear substrate; barrier ribs arranged between the front and rear substrate to define first, second, and third color discharge cells, the discharge cells being filled with a discharge gas; first, second, and third color layers adapted to be excited by the discharge gas and to emit light; and display electrodes arranged on the front substrate, the display electrodes including non-transparent protrusion electrodes protruding inward from edges of the discharge cells. The non-transparent protrusion electrodes of at least two of the first, second, and third color discharge cells have different areas.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on 28 May 2004 and there duly assigned Serial No. 10-2004-0038172.

### BACKGROUND OF THE INVENTION

1. Field of the Invention

The present invention relates to a Plasma Display Panel (PDP), and more particularly, to a PDP using non-transparent protrusion electrodes protruding inward from edges of discharge cells to improve color temperature and Bright Room Contrast Ratio (BRCR).

2. Description of the Related Art

A Plasma Display Panel (PDP) is an image forming apparatus using a plasma discharge to excite phosphor layers. A predetermined voltage is supplied between two electrodes arranged in a discharge space of the PDP to generate the plasma discharge. Vacuum Ultraviolet light (VUV) generated by the plasma discharge excites the phosphor layers. Visible light emitted from the phosphor layers are used to form an image. The PDPs are classified into AC, DC, and hybrid PDPs.

The AC PDP includes a pair of front and rear substrates facing each other. Address electrodes are arranged on the rear substrate. A dielectric layer is arranged to cover the address electrodes. A plurality of barrier ribs are arranged on the dielectric layer to partition the discharge space into a plurality of discharge cells. The barrier ribs maintain a discharge distance and prevent electrical and optical crosstalk between the discharge cells.

In addition, display electrodes including pairs of X and Y electrodes are arranged on the front substrate in a direction intersecting the address electrodes.

The X and Y electrodes are made of Indium Tin Oxide (ITO), which is a transparent material. In order to compensate for the conductivity of the ITO, bus electrodes are made of a metallic material.

Recently, in order to easily generate the plasma discharge, the ITO electrode has been designed to protrude inward from an edge of the discharge cell. In addition, in order to improve Bright Room Contrast Ratio (BRCR) by reducing external light reflection, the metal bus electrode, in a fashion similar to the ITO electrode, has been designed to protrude inward from an edge of the discharge cell.

On the other hand, since Blue (B) phosphor layers emits a lower intensity of light than Red (R) and Green (G) phosphor layers, the B phosphor layers have a lower color temperature.

Therefore, conventionally, a variety of approaches for compensating for the color temperature have been proposed. One approach is to lower peak values of the R and G analog image signals by performing a gamma correction on the R and G analog image signals excluding the B analog image signal (which has a relatively low brightness) and, after that, to perform digitalization, so that the number of sustain pulses for generating the highest brightness of R and G colors can be smaller than the number of sustain pulses for generating the highest brightness of B to improve the color temperature. Another approach is to increase the area of B discharge cells and decrease the area of R and G discharge cells, so that the color temperature can be improved.

All of the 255 sustain pulses need to be used to express the highest brightness of R and G colors. Therefore, in case of expressing a fading-in or fading-out image, the former approach using the gamma correction has a problem in that a step phenomenon occurs in R and G colors.

On the other hand, the latter approach using asymmetrical discharge cells has a problem in that discharge unevenness occurs due to differences between the areas of the discharge cells for different colors. These approaches also have a problem of mis-discharge caused by the discharge unevenness and decrease in a voltage margin for stable driving. In addition, since individual masks for printing the R, G, and B phosphor layers are needed, the approach has increased production costs and decreased visual resolution.

### SUMMARY OF THE INVENTION

An object of the present invention is to provide a plasma display panel using non-transparent protrusion electrodes protruding inward from edges of discharge cells to improve color temperature and Bright Room Contrast Ratio (BRCR).

In order to achieve the object, according to an aspect of the present invention, a Plasma Display Panel (PDP) there is provided comprising: front and rear substrates facing each other; address electrodes arranged on the rear substrate; barrier ribs arranged between the front and rear substrate to define first, second, and third color discharge cells, the discharge cells being filled with a discharge gas; first, second, and third color phosphor layers adapted to be excited by the discharge gas and to emit light; and display electrodes arranged on the front substrate, the display electrodes including non-transparent protrusion electrodes protruding inward from edges of the discharge cells; wherein the non-transparent protrusion electrodes of at least two of the first, second, and third color discharge cells have different areas.

The area of the non-transparent protrusion electrode in the third color discharge cell is preferably smaller than the areas of the non-transparent protrusion electrodes in the first and second color discharge cells.

The non-transparent protrusion electrodes preferably comprise first electrodes protruding inward from the edges of the discharge cells.

The first electrodes preferably extend in a direction parallel to the address electrodes.

The first electrodes alternatively preferably extend in a direction at a predetermined angle with respect to the address electrodes.

The non-transparent protrusion electrodes preferably further comprise second electrodes arranged at ends of the first electrodes.

The first electrodes preferably extend in a direction parallel to the address electrodes; and the second electrodes preferably extend in a direction perpendicular to the first electrodes.

The first electrodes alternatively preferably extend in a direction at a predetermined angle with respect to the address electrodes, and the second electrodes preferably extend in a direction perpendicular to the address electrodes.

Widths of the second electrodes are preferably equal to widths of the first electrodes.

Widths of the second electrodes are alternatively preferably greater than widths of the first electrodes.

The display electrodes preferably further comprise transparent electrodes electrically connected to the non-transparent protrusion electrodes.

The transparent electrodes are preferably arranged within the discharge cells.

The display electrodes preferably have a symmetrical structure.

The display electrodes alternatively preferably have an asymmetrical structure.

The first, second, and third colors preferably comprise red, green and blue.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is an exploded perspective view of a plasma display apparatus according to an embodiment of the present invention;

FIG. 2 is an exploded perspective view of a Plasma Display Panel (PDP) according to an embodiment of the present invention;

FIG. 3 is an schematic view of main components of the PDP of FIG. 2;

FIG. 4 is a schematic view of main components of a PDP according to another embodiment of the present invention; and

FIGS. 5A and 5B are schematic views of main components of a PDP according to still another embodiment of the present invention.

### DETAILED DESCRIPTION OF THE EMBODIMENTS

Embodiments of the present invention are described below in detail with reference to the accompanying drawings.

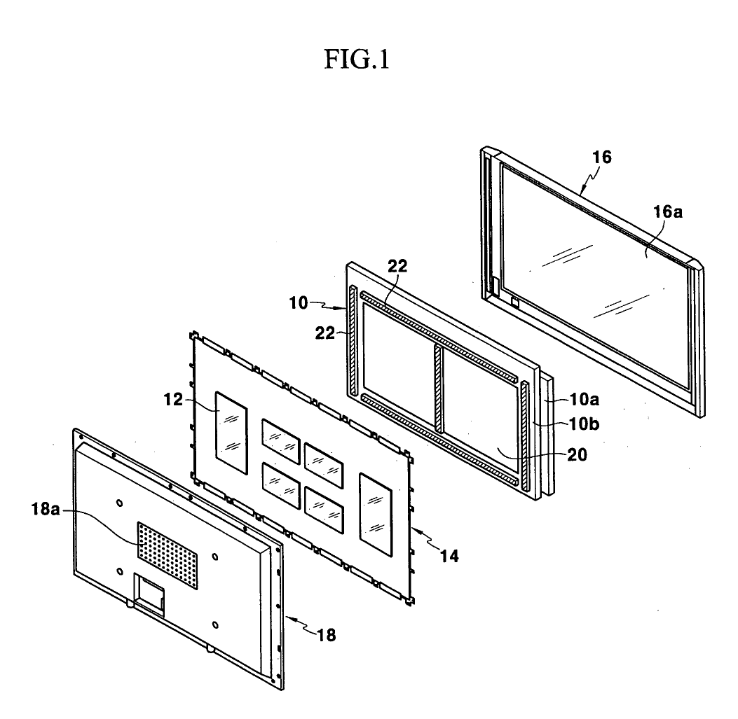

FIG. 1 is an exploded perspective view of a plasma display apparatus according to an embodiment of the present invention.

A PDP 10 comprises front and rear substrates 10a and 10b which are integrally joined with a sealing member such as a frit. A plurality of discharge cells are provided in the PDP. A plasma discharge is generated in the discharge cells. Vacuum Ultraviolet (VUV) light generated by the plasma discharge excites phosphor layers. Visible light emitted by the phosphor layers are used to form an image.

The plasma display apparatus having the PDP 10 includes: a chassis base 14 for supporting the rear substrate of the PDP 10 and mounting a plurality of printed circuit board assemblies 12; a front cabinet 16 arranged in front of the PDP 10; and a back cover 18 arranged behind the chassis base 14 to surround the PDP 10 and the chassis base 14. The front cabinet 16 and the back cover 18 are integrally assembled to cover the plasma display apparatus.

More specifically, a variety of printed circuit board assemblies 12 are mounted on the rear surface of the chassis base 14 facing the back cover 18. The printed circuit board assemblies 12 include a power supply board, an image processing board, an address buffer board, and X and Y boards. In order to dissipate heat generated by the PDP 10 and the circuit board assemblies 12, the chassis base 14 is made of an effective heat-radiating material or formed as an effective heat-radiating structure.

A conductive film filter 16a for preventing an electrostatic phenomenon is provided on the front cabinet 16. The conductive film filter 16a is in contact with the front substrate 10a. A plurality of air vent holes 18a are provided in the back cover 18 to release heat generated by the PDP 10 of the plasma display apparatus.

The plasma display apparatus includes heat-conductive media 20 for transferring the heat generated by the PDP 10. The heat-conductive media 20 is arranged between the PDP 10 and the chassis base 14. In addition, an adhesive member 22, such as double-sided adhesive tape, is arranged along an edge of the rear substrate 10b of the PDP 10 to affix the PDP 10 to the chassis base 14. In addition to affixing the PDP 10 to the chassis base 14, the adhesive member 22 maintains a distance between the PDP 10 and the chassis base 14 and absorbs external impact.

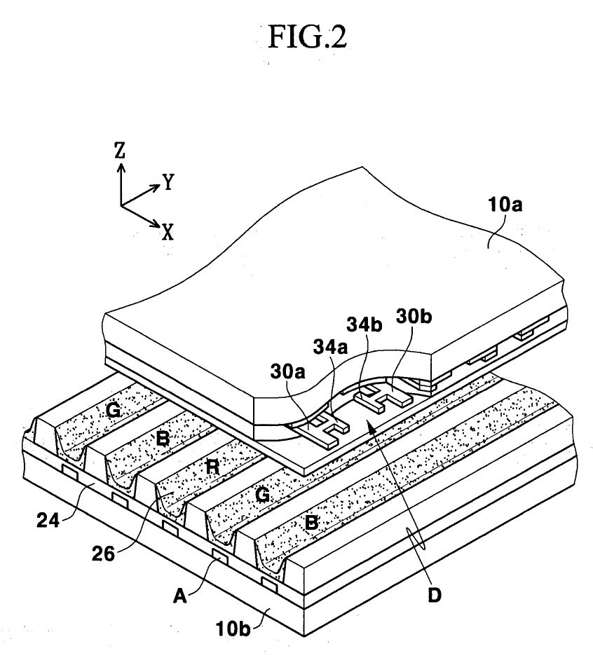

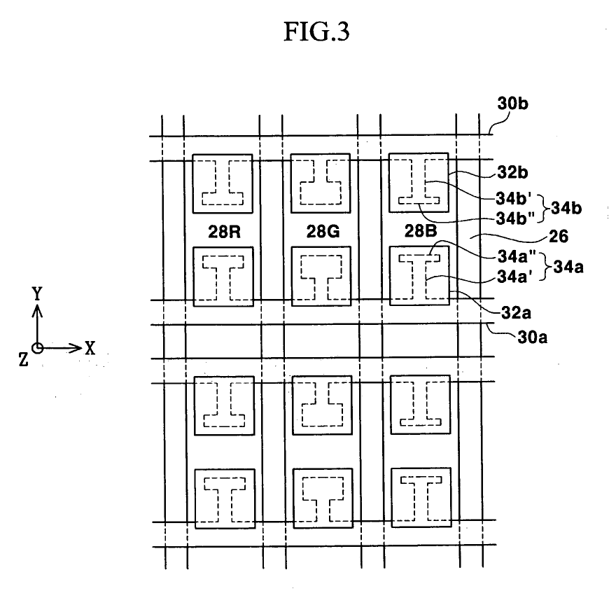

An embodiment of the present invention is described below with reference to FIGS. 2 and 3.

FIG. 2 is an exploded perspective view of a PDP according to the embodiment of the present invention. FIG. 3 is a schematic view of main components of the PDP of FIG. 2.

Address electrodes A are arranged on an inner surface of the rear substrate 10b. A dielectric layer 24 covers the address electrodes A on the inner surface of the rear substrate 10b. Barrier ribs 26 are arranged on the dielectric layer 24 in stripes in the direction parallel to the address electrodes A. Red, Green and Blue phosphor layers R, G, and B are coated on bottoms (dielectric layer 24) and walls (barrier ribs 26) of the discharge cells partitioned by the barrier ribs 26. Hereinafter, the discharge cells coated with the phosphor layers R, G, and B will be referred to as red, green, and blue discharge cells 28R, 28G, and 28B, respectively.

Display electrodes D are arranged on an inner surface of the front substrate 10a in a direction intersecting the address electrodes A. In this embodiment, each of the display electrodes D comprises a pair of bus electrodes 30a and 30b, a pair of transparent electrodes 32a and 32b electrically connected to the bus electrodes 30a and 30b, and a pair of non-transparent protrusion electrodes 34a and 34b electrically connected to the transparent electrodes 32a and 32b. The pair of transparent electrodes 32a and 32b protrude inward from edges of the discharge cells 28R, 28G, and 28B in order to easily generate discharges between the electrodes.

In a fashion similar to the transparent electrodes 32a and 32b, the non-transparent protrusion electrodes 34a and 34b protrude inward from edges of the discharge cells 28R, 28G, and 28B in order to prevent a decrease in the BRCR due to reflection of external light incident to the front substrate 10a.

In addition, the non-transparent protrusion electrodes 34a and 34b compensate the color temperature of the PDP. In order to compensate the color temperature, the non-transparent protrusion electrodes 34a and 34b have different areas according to the colors of the discharge cells 28R, 28G, and 28B.

In general, the R, G, and B phosphor layers coated in the discharge cells 28R, 28G, and 28B emit light of different brightnesses. The brightness of the B phosphor layer is lower than that of the G phosphor layer.

When the discharge cells 28R, 28G, and 28B have the same size, in order to compensate the color temperature, the brightness of the discharge cells 28G and 28B must be adjusted to suitable levels. Therefore, in this embodiment, the area of the non-transparent protrusion electrodes 34a and 34b in the discharge cell 28G is larger than the area of the non-transparent protrusion electrodes 34a and 34b in the discharge cell 28B. The areas of the non-transparent protrusion electrodes 34a and 34b in the discharges cells can be adjusted by changing the widths of the electrodes.

In this embodiment, the non-transparent protrusion electrodes 34a and 34b comprise first electrodes 34a′ and 34b′ protruding inward from edges of the discharge cells 28R, 28G, and 28B, and second electrodes 34a″ and 34b″ arranged at ends of the first electrodes 34a′ and 34b′. The first electrodes 34a′ and 34b′ extend in the direction (Y direction in the figure) parallel to the address electrodes A. The second electrodes 34a″ and 34b″ extend in the direction (X direction in the figure) perpendicular to the first electrodes 34a′ and 34b′.

The shapes and directions of the first and second electrodes are not limited to those illustrated herein, but rather various modifications thereof are possible.

In addition, the widths of the second electrodes 34a″ and 34b″ can be equal to or greater than those of the first electrodes 34a′ and 34b′.

The transparent electrodes 32a and 32b are not essential components and can be selectively removed if necessary.

Although the display electrodes D are symmetric structures in this embodiment, the display electrodes D can be asymmetric structures. For example, only one of the X and Y electrodes can be a non-transparent electrode. In addition, although both the X and Y electrodes can be non-transparent electrodes, it is not necessary for the non-transparent electrodes to have the same shape.

Accordingly, in the PDP having the non-transparent protrusion electrodes 34a and 34b, a decrease in the BRCR due to the reflection of external light can be prevented by the non-transparent protrusion electrodes 34a and 34b. In addition, since the areas of the non-transparent protrusion electrodes 34a and 34b in the green discharge cell 28G are larger than the areas of the non-transparent protrusion electrodes 34a and 34b in the blue discharge cell 28B, the color temperature of the PDP can be compensated by adjusting the areas of the non-transparent protrusion electrodes.

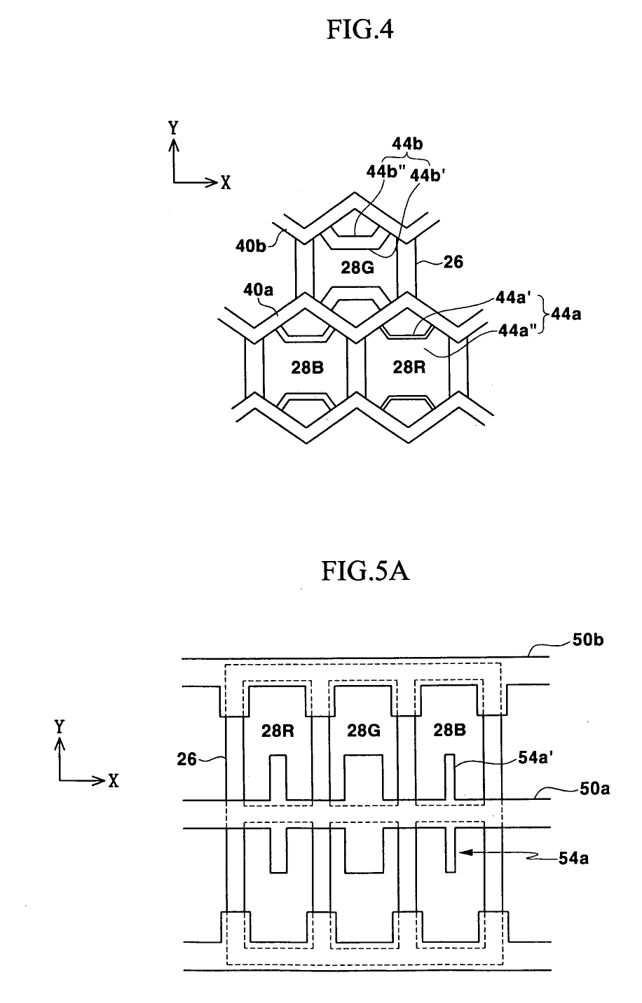

FIG. 4 is a schematic view of main components of a PDP according to another embodiment of the present invention. In the description below, the same components as those of the embodiment of FIGS. 2 and 3 are denoted by the same reference numerals.

This embodiment relates to a PDP with a delta pixel arrangement. In the PDP, bus electrodes 40a and 40b are arranged along barrier ribs 26. One of the bus electrodes 40a and 40b is used as a common electrode.

In each of the discharge cells 28R, 28G, and 28B, a pair of non-transparent protrusion electrodes 44a and 44b are arranged to protrude and face each other. The non-transparent protrusion electrodes 44a and 44b comprise first electrodes 44a″ and 44b″ in a direction at a predetermined angle to the Y axis direction parallel to address electrodes and second electrodes 44a″ and 44b″ in the X axis direction perpendicular to the Y axis direction.

Although the display electrodes D are symmetric structures in the embodiment, the display electrodes D can be asymmetric structures.

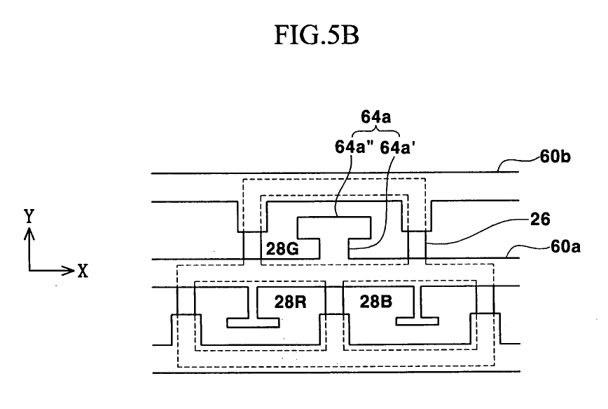

FIGS. 5A and 5B are schematic views of main components of a PDP according to still another embodiment of the present invention. In this embodiment, the display electrodes D are asymmetric structures.

In a fashion similar to the PDP of FIG. 4, in the PDP according to this embodiment, one of bus electrodes 50a and 50b (60a and 60b) is used as a common electrode. Only one of the bus electrodes 50a and 50b (60a and 60b) is a non-transparent protrusion electrode.

The non-transparent protrusion electrode 54 of the bus electrode 50a includes only the first electrode 54a′ in the PDP of FIG. 5A. On the other hand, in a fashion similar to the PDP of FIGS. 2 and 3, the non-transparent protrusion electrode includes the first and second electrodes 64a′ and 64b′ in the PDP of FIG. 5B.

According to a PDP in accordance with an embodiment of the present invention, since the reflection of external light is reduced by the non-transparent protrusion electrodes protruding inward from the edges of the discharge cells, it is possible to improve the BRCR. In addition, since the color temperature can be compensated, it is possible to solve conventional problems occurring in compensating the temperature by performing a gamma correction and using uneven barrier ribs.

Although not shown in the drawings, a PDP according to the present invention can be constructed with various shapes of barrier ribs and other components. Therefore, any PDPs having non-transparent protrusion electrodes protruding inward from edges from discharge cells with different areas according to the colors of the discharge cells will be construed as being included within the scope of the present invention.

While the present invention has been particularly shown and described with reference to exemplary embodiments thereof, it will be understood by those skilled in the art that various modifications in form and detail can be made therein without departing from the spirit and scope of the present invention as defined by the appended claims.

1. A Plasma Display Panel (PDP), comprising:
front and rear substrates facing each other;
address electrodes arranged on the rear substrate;
barrier ribs arranged between the front and rear substrate to define first, second, and third color discharge cells, the discharge cells being filled with a discharge gas;
first, second, and third color phosphor layers adapted to be excited by the discharge gas and to emit light; and
display electrodes arranged on the front substrate, the display electrodes including non-transparent protrusion electrodes protruding inward from edges of the discharge cells;
wherein the non-transparent protrusion electrodes of at least two of the first, second, and third color discharge cells have different areas.

2. The PDP of claim 1, wherein the area of the non-transparent protrusion electrode in the third color discharge cell is smaller than the areas of the non-transparent protrusion electrodes in the first and second color discharge cells.

3. The PDP of claim 1, wherein the non-transparent protrusion electrodes comprise first electrodes protruding inward from the edges of the discharge cells.

4. The PDP of claim 3, wherein the first electrodes extend in a direction parallel to the address electrodes.

5. The PDP of claim 3, wherein the first electrodes extend in a direction at a predetermined angle with respect to the address electrodes.

6. The PDP of claim 3, wherein the non-transparent protrusion electrodes further comprise second electrodes arranged at ends of the first electrodes.

7. The PDP of claim 6, wherein the first electrodes extend in a direction parallel to the address electrodes and wherein the second electrodes extend in a direction perpendicular to the first electrodes.

8. The PDP of claim 6, wherein the first electrodes extend in a direction at a predetermined angle with respect to the address electrodes and wherein the second electrodes extend in a direction perpendicular to the address electrodes.

9. The PDP of claim 6, wherein widths of the second electrodes are equal to widths of the first electrodes.

10. The PDP of claim 6, wherein widths of the second electrodes are greater than widths of the first electrodes.

11. The PDP of claim 3, wherein the display electrodes further comprise transparent electrodes electrically connected to the non-transparent protrusion electrodes.

12. The PDP of claim 11, wherein the transparent electrodes are arranged within the discharge cells.

13. The PDP of claim 11, wherein the display electrodes have a symmetrical structure.

14. The PDP of claim 11, wherein the display electrodes have an asymmetrical structure.

15. The PDP of claim 1, wherein the first, second, and third colors comprise red, green and blue.

16. The PDP of claim 2, wherein the first, second, and third colors comprise red, green and blue.
